(19) United States
(12) Patent Application Publication
(10) Pub. No.: US 2010/0224654 A1
(43) Pub. Date: Sep. 9, 2010

(54) Spray Device

(76) Inventor: Joon T. Choi, Los Angeles, CA (US)

Correspondence Address: PARK LAW FIRM, 3255 WILSHIRE BLVD, SUITE 1110, LOS ANGELES, CA, 90010, US

(21) Appl. No.: 12/400,181

(22) Filed: Mar. 9, 2009

(51) Int. Cl. B05B 11/00; B67D 5/40

(52) U.S. Cl. 222/382; 222/464.4

(57) ABSTRACT

An aspect of the invention provides a spray device for siphoning fluid. The spray device comprises a container, a pump, and a siphon tube. The container has an opening at a top portion. The pump is provided on the opening of the container. The siphon tube extends from the pump down to a bottom portion of the container, and the siphon tube comprises a flexible portion in a middle portion of the siphon tube for allowing a lower end portion to fall downward under gravity when the spray device is tilted from a vertical position. The lower portion of the siphon tube is configured to reach center or corners of the bottom portion of the container. The flexible portion of the siphon tube may be disposed in the middle portion of the siphon tube such that the lower portion below the flexible portion falls downward due to weight of the lower portion due to gravity.

### BACKGROUND OF THE INVENTION

The present invention relates to a spray device. More particularly, this invention relates to a spray device, which is able to siphon fluid in a corner of bottle.

Spray bottles are popular in many areas of home maintenance. Squirting out or spraying fluid is needed in situations to apply droplets or mist of liquid to a surface or volume.

Pumping action cause fluid in a bottle to be pumped up through a tube and squirted out of a nozzle.

However, the traditional spray bottles have problems when a user tries to spray the fluid in certain locations. Sometimes, it gets harder to spray or has the pumping action working properly. In other times, it is challenging to use up the fluid in the bottle.

Accordingly, a need for a spray device has been present for a long time considering the expansive demands in the everyday life. This invention is directed to solve these problems and satisfy the long-felt need.

### SUMMARY OF THE INVENTION

The present invention contrives to solve the disadvantages of the prior art.

An objective of the invention is to provide a spray device.

Another object of the invention is to provide a spray device for siphoning fluid in a corner of bottle.

Still another object of the invention is to provide a spray device having a flexible portion in a siphon tube.

An aspect of the invention provides a spray device for siphoning fluid.

The spray device comprises a container, a pump, and a siphon tube.

The container has an opening at a top portion. The pump is provided on the opening of the container.

The siphon tube extends from the pump down to a bottom portion of the container, and the siphon tube comprises a flexible portion in a middle portion of the siphon tube for allowing a lower end portion to fall downward under gravity when the spray device is tilted from a vertical position.

The lower portion of the siphon tube is configured to reach center or corners of the bottom portion of the container.

The flexible portion of the siphon tube may be disposed in the middle portion of the siphon tube such that the lower portion below the flexible portion falls downward due to weight of the lower portion due to gravity.

The flexible portion of the siphon tube may be disposed above a half point of the siphon tube. Alternatively, the flexible portion of the siphon tube may be disposed below a half point of the siphon tube.

In certain embodiments, the flexible portion of the siphon tube may be disposed about at a half point of the siphon tube.

The spray device may further comprise a weight disposed at the lower end portion of the siphon tube for facilitating falling down of the lower end portion of the siphon tube.

The weight may be predetermined according to a critical bending force of the flexible portion of the siphon tube.

The weight may be disposed at a tip of the lower end portion of the siphon tube.

Alternatively, the weight may be disposed at a location higher than a tip of the lower end portion of the siphon tube by a predetermined height.

The weight may be embedded in the lower end portion of the siphon tube.

The flexible portion may comprise rubber.

In certain embodiments, the flexible portion may comprise a concertina-type hinge.

Another aspect of the invention provides a spray device for siphoning fluid, the spray device comprising: a container having an opening at a top portion; a pump provided on the opening of the container; and a siphon tube extending from the pump down to a bottom portion of the container, wherein the siphon tube is flexible for allowing a lower end portion to fall downward under gravity when the spray device is tilted from a vertical position.

The whole siphon tube is made flexible. Except that, the other features may be similar to the previous embodiments of the invention.

The advantages of the present invention are: (1) the spray device can reach nearly all bottom portion of the container; and (2) the spray device can be tilted sideways arbitrarily, and reach fluids left in a small amount in the bottle.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a perspective view showing a spray device in a prior art;

FIG. 2 is a perspective view showing a spray device in a tilted position in FIG. 1;

FIG. 3 is a perspective view showing a spray device according to an embodiment of the invention;

FIG. 4 is a perspective view showing a spray device in a tilted position in FIG. 3;

FIG. 5 is a perspective view showing a spray device according to another embodiment of the invention;

FIG. 6 is a cross-sectional view of a tip of a siphon tube according to an embodiment of the invention;

FIG. 7 is a cross-sectional view of a tip of a siphon tube according to another embodiment of the invention;

FIG. 8 is a cross-sectional view of a tip of a siphon tube according to still another embodiment of the invention; and

FIG. 9 is a cross-sectional view of a tip of a siphon tube according to still another embodiment of the invention.

### DETAILED DESCRIPTION EMBODIMENTS OF THE INVENTION

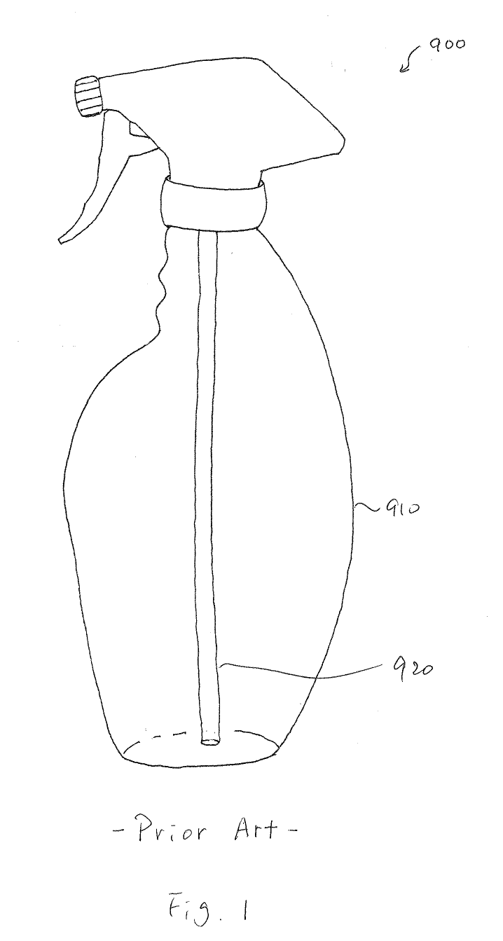

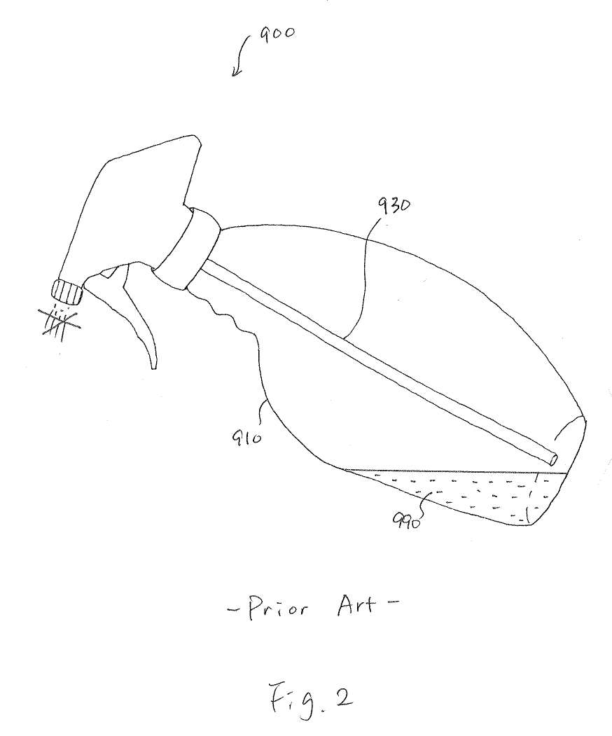

FIGS. 1 and 2 show a traditional spray bottle 900 in prior arts.

As clearly shown in FIGS. 1 and 2, the spray bottle 900 in prior arts has problems. Since the 930 is stiff or non-responsive to the gravity, the tip of the siphon tube 930 cannot reach certain points in a bottom portion of the container 910, and to the fluid 990.

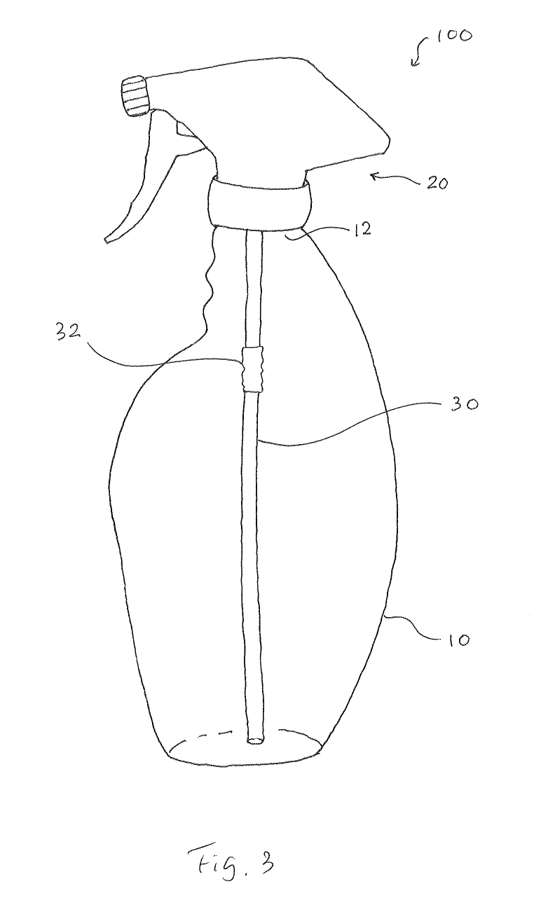

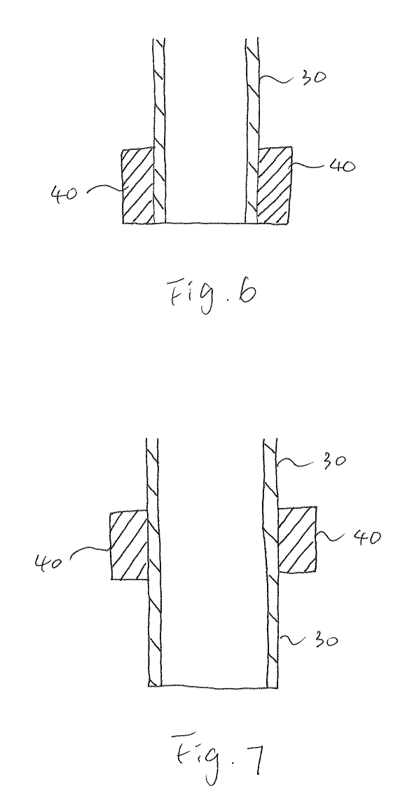

FIGS. 3-5 show a spray device 100 according to embodiments of the present invention. FIGS. 6-9 show a tip of siphon tube of the spray device 100 according to other embodiments of the invention.

An aspect of the invention provides the spray device 100 for siphoning fluid.

The spray device 100 comprises a container 10, a pump 20, and a siphon tube 30.

The container 10 has an opening 12 at a top portion. The pump 20 is provided on the opening 12 of the container 10.

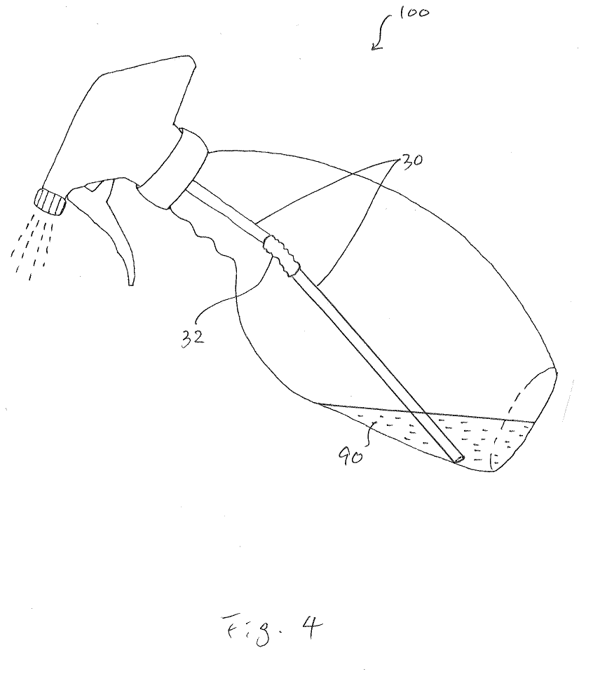

The siphon tube 30 extends from the pump 20 down to a bottom portion of the container 10, and the siphon tube 30 comprises a flexible portion 32 in a middle portion of the siphon tube 30 for allowing a lower end portion to fall downward under gravity when the spray device 100 is tilted from a vertical position as shown in FIG. 4.

The lower portion of the siphon tube 30 is configured to reach center or corners of the bottom portion of the container 10.

The flexible portion 32 of the siphon tube 30 may be disposed in the middle portion of the siphon tube 30 such that the lower portion below the flexible portion 32 falls downward due to weight of the lower portion due to gravity.

The flexible portion 32 of the siphon tube 30 may be disposed above a half point of the siphon tube 30. Alternatively, the flexible portion 32 of the siphon tube 30 may be disposed below a half point of the siphon tube 30.

In certain embodiments, the flexible portion 32 of the siphon tube 30 may be disposed about at a half point of the siphon tube 30.

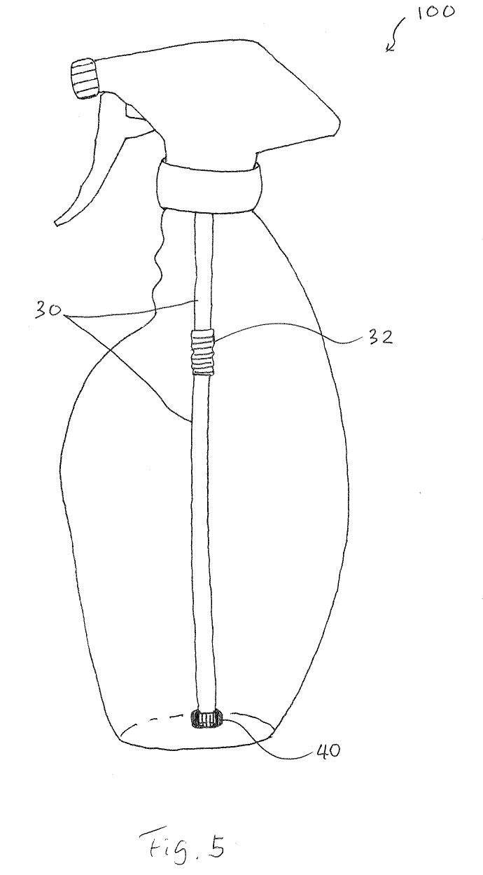

The spray device 100 may further comprise a weight 40 disposed at the lower end portion of the siphon tube 30 for facilitating falling down of the lower end portion of the siphon tube 30 as shown in FIG. 5.

The weight 40 may be predetermined according to a critical bending force of the flexible portion of the siphon tube 30.

The weight 40 may be disposed at a tip of the lower end portion of the siphon tube 30 as shown in FIGS. 5 and 6.

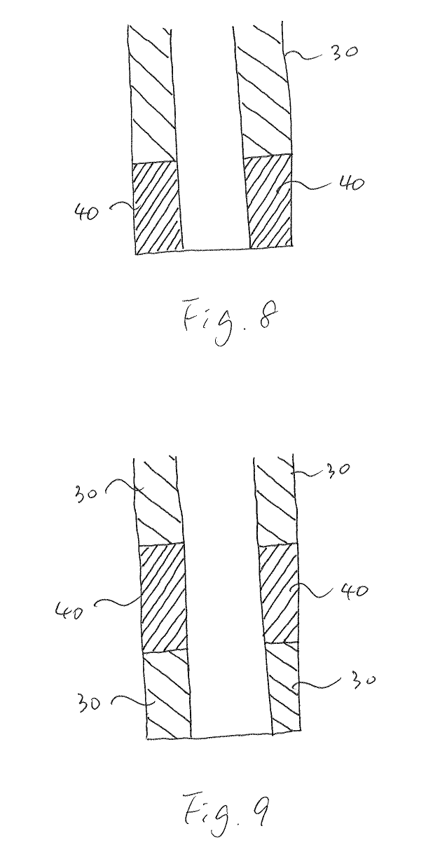

Alternatively, the weight 40 may be disposed at a location higher than a tip of the lower end portion of the siphon tube 30 by a predetermined height as shown in FIG. 7. Thereby, the tip of the siphon tube 30 may reach inner surfaces of the container 10 or the fluid easily.

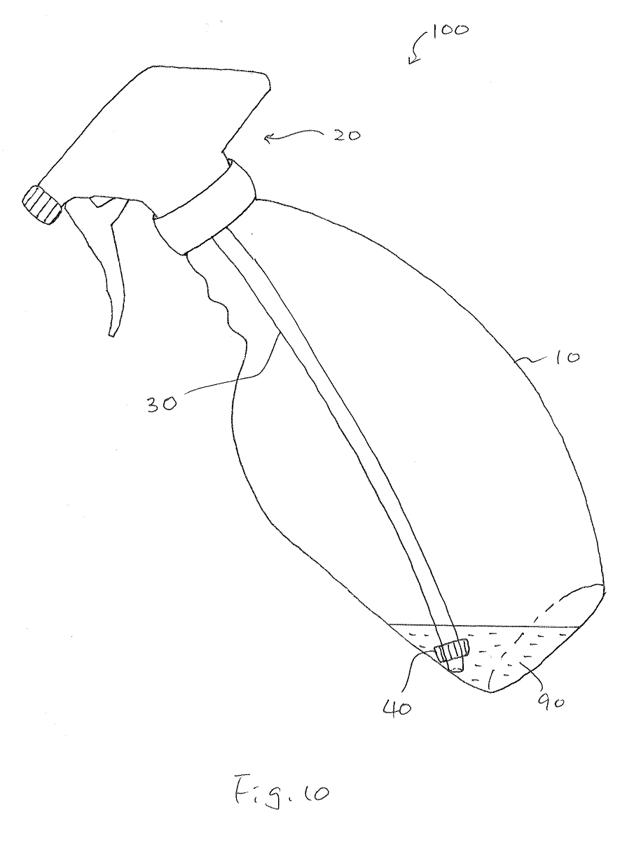

The weight 40 may be embedded in the lower end portion of the siphon tube 30 as shown in FIGS. 8 and 9.

The flexible portion 32 may comprise rubber.

In certain embodiments, the flexible portion 30 may comprise a concertina-type hinge. The structure and elastic property of the concertina-type hinge may be controlled by mass or angular momentum of the lower portion of the siphon tube 30 below the flexible portion 32.

Another aspect of the invention provides a spray device 100 for siphoning fluid, the spray device 30 comprising: a container 10 having an opening at a top portion; a pump 20 provided on the opening of the container 10; and a siphon tube 30 extending from the pump 20 down to a bottom portion of the container 10, wherein the siphon tube 30 is flexible for allowing a lower end portion to fall downward under gravity when the spray device 100 is tilted from a vertical position.

The whole siphon tube 30 is made flexible as shown in FIG. 10. Since the whole parts of the siphon tube 30 are flexible, its tip is freely fallen down by the gravity. With the weight 40, such a falling down motion may be facilitated. Except that, the other features may be similar to the previous embodiments of the invention.

As shown in FIGS. 4 and 10, the fluid 90 is left by a small amount, but can be pumped up and sprayed with the spray device 100 is tilted.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. A spray device for siphoning fluid from a bottle, the spray device comprising:
a container having an opening at a top portion;
a pump provided on the opening of the container; and
a siphon tube extending from the pump down to a bottom portion of the container, the siphon tube comprising a flexible portion in a middle portion of the siphon tube for allowing a lower end portion to fall downward under gravity when the spray device is tilted from a vertical position,
wherein the lower portion of the siphon tube is configured to reach center or corners of the bottom portion of the container.

2. The spray device of claim 1, wherein the flexible portion of the siphon tube is disposed in the middle portion of the siphon tube such that the lower portion below the flexible portion falls downward due to weight of the lower portion due to gravity.

3. The spray device of claim 2, wherein the flexible portion of the siphon tube is disposed above a half point of the siphon tube.

4. The spray device of claim 2, wherein the flexible portion of the siphon tube is disposed below a half point of the siphon tube.

5. The spray device of claim 2, wherein the flexible portion of the siphon tube is disposed about at a half point of the siphon tube.

6. The spray device of claim 1, further comprising a weight disposed at the lower end portion of the siphon tube for facilitating falling down of the lower end portion of the siphon tube.

7. The spray device of claim 6, wherein the weight is predetermined according to a critical bending force of the flexible portion of the siphon tube.

8. The spray device of claim 6, wherein the weight is disposed at a tip of the lower end portion of the siphon tube.

9. The spray device of claim 6, wherein the weight is disposed at a location higher than a tip of the lower end portion of the siphon tube by a predetermined height.

10. The spray device of claim 6, wherein the weight is embedded in the lower end portion of the siphon tube.

11. The spray device of claim 1, wherein the flexible portion comprises rubber.

12. The spray device of claim 1, wherein the flexible portion comprises a concertina-type hinge.

13. A spray device for siphoning fluid from a bottle, the spray device comprising:
a container having an opening at a top portion;
a pump provided on the opening of the container; and
a siphon tube extending from the pump down to a bottom portion of the container, wherein the siphon tube is flexible for allowing a lower end portion to fall downward under gravity when the spray device is tilted from a vertical position,
wherein the lower portion of the siphon tube is configured to reach center or corners of the bottom portion of the container.

14. The spray device of claim 13, wherein the weight is predetermined according to a critical bending force of the flexible portion of the siphon tube.

15. The spray device of claim 13, wherein the weight is disposed at a tip of the lower end portion of the siphon tube.

16. The spray device of claim 13, wherein the weight is disposed at a location higher than a tip of the lower end portion of the siphon tube by a predetermined height.

17. The spray device of claim 13, wherein the weight is embedded in the lower end portion of the siphon tube.
